(19) United States
(12) Patent Application Publication
(10) Pub. No.: US 2017/0205921 A1
(43) Pub. Date: Jul. 20, 2017

(54) DISPLAY SUBSTRATE, DISPLAY PANEL AND DISPLAY APPARATUS HAVING THE SAME, AND FABRICATING METHOD THEREOF

(71) Applicants: BOE TECHNOLOGY GROUP CO., LTD., Beijing (CN); Chengdu BOE Optoelectronics Technology Co., Ltd., Chengdu (CN)

(72) Inventors: Benyin Ye, Beijing (CN); Zhidong Wang, Beijing (CN); Benlian Wang, Beijing (CN)

(73) Assignees: BOE TECHNOLOGY GROUP CO., LTD., Beijing (CN); Chengdu BOE Optoelectronics Technology Co., Ltd., Chengdu (CN)

(21) Appl. No.: 15/325,872

(22) PCT Filed: May 20, 2016
(86) PCT No.: PCT/CN2016/082893

§ 371 Date: Jan. 12, 2017

(30) Foreign Application Priority Data
Aug. 20, 2015 (CN) 201510516472.7

(51) Int. Cl. G06F 3/041; G02F 1/1333; G06F 3/044

(52) U.S. Cl. CPC G06F 3/0412; G06F 3/0416; G06F 3/044; G02F 1/13338; G06F 2203/04103; G06F 2203/04104

(57) ABSTRACT

The present application discloses a display substrate comprising an electrode layer comprising an array of electrode units; each electrode unit comprises a first electrode and a second electrode in a one-to-one relationship; the first electrode is electrically isolated from the second electrode. The second electrode is a common electrode being controlled independently from the first electrode.

### CROSS-REFERENCE TO RELATED APPLICATION

This application claims priority to Chinese Patent Application No. 201510516472.7, filed on Aug. 20, 2015, the contents of which are incorporated by reference in the entirety.

### TECHNICAL FIELD

The present invention relates to display technology, more particularly, to a display substrate, a display panel and a display apparatus having the same, and a fabricating method thereof.

### BACKGROUND

In recent years, touch devices have been widely used in many electronic devices such as mobile phones, computer display panels, touch screens, satellite navigation devices, digital cameras, etc. Examples of touch devices include a mutual capacitive touch control device and a self-capacitive touch control device, In a mutual capacitive touch control device, the touch electrode can be a touch scanning electrode (Tx), whereas the touch sensing electrode (Rx) can be disposed on the color filter substrate. in a self-capacitive touch control device, the touch electrode can achieve touch control function alone. Self-capacitive touch control devices have become the focus of research in display technology due to its advantages of low power consumption, an improved accuracy, and a straightforward operation.

### SUMMARY

In one aspect, the present invention provides a display substrate comprising an electrode layer comprising an array of electrode units; each electrode unit comprises a first electrode and a second electrode in a one-to-one relationship; the first electrode is electrically isolated from the second electrode.

Optionally, the second electrode is a common electrode being controlled independently from the first electrode.

Optionally, the first electrode is operated in a time-division driving mode.

Optionally, the time-division driving mode comprises a display mode and a touch control mode; the first electrode and the second electrode are common electrodes for applying common voltage signal during the display mode; the first electrode is a touch control electrode for conducting touch signals during the touch control mode.

Optionally, each electrode unit comprises a first portion having a first shape and a second portion having a second shape complementary to the first shape, the first portion and the second portion are different electrodes selected from the first electrode and the second electrode.

Optionally, the second portion is an inner portion and the first portion is an outer portion surrounding the inner portion; the inner portion is the first electrode and the outer portion is the second electrode.

Optionally, the second portion is an inner portion and the first portion is an outer portion surrounding the inner portion; the inner portion is the second electrode and the outer portion is the first electrode.

Optionally, the first shape is a rectangle, a triangle, or a rhomboid.

Optionally, all first electrodes have a substantially uniform shape and dimension, and all second electrodes have a substantially uniform shape and dimension.

Optimally, a plurality of first electrodes along a same array direction are electrically connected.

Optionally, the plurality of first electrodes are electrically connected by a first wire, the first wire being a transparent wire extending through each of the plurality of first electrodes.

Optionally, a plurality of second electrodes along a same array direction are electrically connected by a second wire.

Optionally, the display substrate is a dual gate-type display substrate, the firs and/or the second wire are dummy lines in the dual gate-type display substrate.

Optionally, the display substrate further comprises an array of pixel electrodes; each pixel electrode corresponding to each electrode unit in a one-to-one relationship.

Optionally, each first electrode is at a position corresponding to each pixel electrode in plan view of the display substrate.

In another aspect, the present invention provides a method of fabricating a display substrate, the method comprising forming an electrode layer comprising an array of electrode units on a base substrate; each electrode unit comprises a first electrode and a second electrode in a one-to-one relationship; the first electrode is electrically isolated from the second electrode; the second electrode is a common electrode; and forming at least one driving circuit for controlling the first electrode and the second electrode independently.

Optionally, the method further comprises forming an array of pixel electrodes; each pixel electrode corresponding to each electrode unit in a one-to-one relationship.

Optionally, each first electrode is at a position corresponding to each pixel electrode in plan view of the display substrate.

Optionally, each electrode unit comprises a first portion having a first shape and a second portion having a second shape complementary to the first shape, the first portion and the second portion are different electrodes selected from the. first electrode and the second electrode.

Optionally, the second portion is an inner portion and the first portion is an outer portion surrounding the inner portion; the inner portion is the first electrode and the outer portion is the second electrode.

Optionally, the second portion is an inner portion anti the first portion is an outer portion surrounding the inner portion; the inner portion is the second electrode and the outer portion is the first electrode.

Optionally, the step of forming an electrode layer comprises forming a conductive layer on the base substrate; and partitioning the conductive layer into a plurality of electrode blocks, each electrode block comprising a first electrode and a second electrode.

Optionally, the method further comprises forming a first wire connecting a plurality of first electrodes along a same array direction.

Optionally, the method further comprises forming a second wire connecting a plurality of second electrodes along a same array direction.

Optionally, the display substrate is a dual gate-type display substrate, the method further comprising forming a plurality of dummy lines in the dual gate-type display substrate.

Optionally, the first wire and/or the second wire are dummy lines in the dual gate-type display substrate.

In another aspect, the present invention provides a display apparatus described herein or fabricated by a method described herein.

In another aspect, the present invention provides a method of driving a display apparatus described herein or fabricated by a method described herein, wherein one frame period is temporally divided into a display mode for displaying an image in a display panel and a touch control mode for sensing a user touch, the display panel is alternately driven in the display mode and in the touch control mode, the method comprising applying a common voltage to the first electrode and the second electrode during the display mode; and applying a touch scan signal to the first electrode during the touch control mode.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the structure of a convention display substrate.

FIG. 2 is a diagram illustrating the voltage change as a function of time in a touch control electrode block in some embodiments.

FIG. 3 is a diagram illustrating the structure of a display substrate in so embodiments.

FIG. 4 is a diagram illustrating the structure of a combined electrode block A11 having a first electrode block (P1) and a second electrode block (P2) in some embodiments.

FIG. 5 is a diagram illustrating the structure of a combined electrode block having a first electrode block (P1) and two second electrode blocks (P2) in some embodiments.

FIG. 6 is a diagram illustrating a wiring design for connecting a plurality of second electrode blocks (P2) in a same row in some embodiments.

FIG. 7 is a diagram illustrating the structure of a dual gate-type display substrate in some embodiments.

FIG. 8 is a flow chart illustrating a method of fabricating a display substrate in some embodiments.

### DETAILED DESCRIPTION

The disclosure will now describe more specifically with reference to the following embodiments. It is to be noted that the following descriptions of some embodiments are presented herein for purpose of illustration and description only. It is not intended to be exhaustive or to be limited to the precise form disclosed.

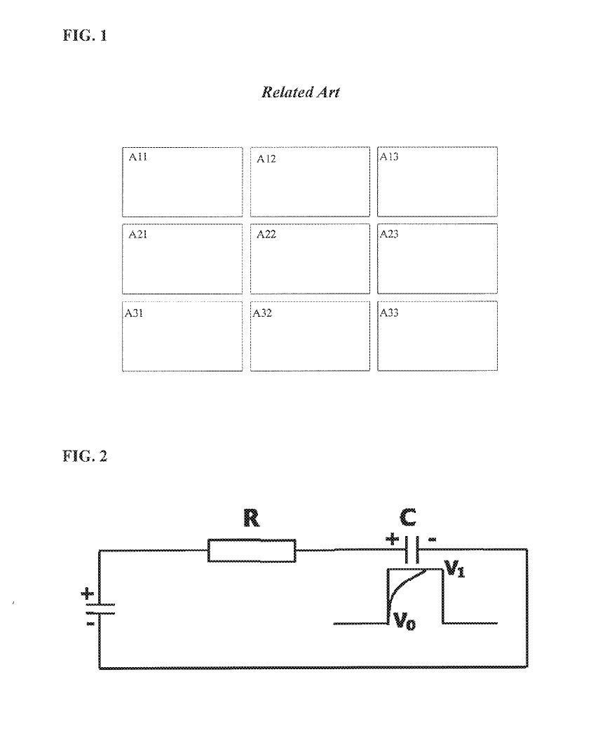

FIG. 1 is a diagram illustrating the structure of a convention display substrate. Referring to FIG. 1, the display substrate in the embodiment is a self-capacitive touch substrate. The common electrode layer of the display substrate includes a plurality of touch electrodes (A11, A12, A12, A21, A22, A23, A31, A32, and A33), Each touch electrode is operated in time-division driving mode. For example, the touch electrode is used for conducting touch signals in touch control mode, and for applying common voltage in display mode. Each electrode is electrically connected to a driving circuit at the peripheral portion of the display panel.

The present disclosure identifies several issues with the conventional display substrate. One issue relates to the touch sensitivity of the display substrate. Each electrode forms a capacitor with ground. During touch control mode, the touch control becomes operable when the voltage on the capacitance reaches a certain level. FIG. 2 is a diagram illustrating the voltage change as a function of time in a touch control electrode block in some embodiments. Referring to FIG. 2, the charging time duration T required for the voltage to increase to V can be expressed as:

T=RC*In [(Vᵤ−V₀)/(Vᵤ−V₁)] (1)

wherein Vᵤ is the output voltage of a voltage source; V₀ is the initial voltage on the capacitor, V₁ is the voltage required for the touch control to be operable, and T is the charging time duration required for the voltage to increase from V₀ to V₁. Based on equation (1), the touch control sensitivity is closely correlated to the charging time duration T. Typically, the conventional touch control display panel has a relatively long charging time duration T, resulting in a low touch control sensitivity.

Based on the above, the touch control sensitivity can be improved by decreasing the charging time duration T required for the voltage to increase to V₁. Because the charging time duration T is correlated to the touch electrode capacitance C, the charging time duration T may be decreased by lowering the value of capacitance C, which is in turn correlated with the surface area of the touch electrode. Accordingly, the touch control sensitivity can be greatly improved by using a touch electrode having a smaller surface area.

The present disclosure provides a superior touch control display substrate, in some embodiments, the display substrate includes an electrode layer having an array of electrode units. The electrode units are spaced apart from each other. Each electrode unit includes a first electrode and a second electrode in a one-to-one relationship, the first electrode being electrically isolated from the second electrode. For example, the first electrode may be electrically isolated from the second electrode by a gap. Optionally, to form an electrode layer having this structure, a layer of conductive material may be deposited on a base substrate by sputtering, evaporating, or chemical vapor deposition. The region corresponding to the gap may be removed by etching, e.g., chemical etching, laser etching or mechanical etching. The first electrode is proximal to, but separated from, the second electrode. The first electrode and the second electrode are in a same layer. Optionally, the first electrode and the second electrode are insulated from each other. Optionally, the second electrode is a common electrode for applying common voltage signal for image display.

Optionally, the second electrode includes two or more sub-electrodes. For example, each electrode unit may include a first electrode having only one first sub-electrode and a second electrode having two second sub-electrodes, the first sub-electrode being electrically isolated from the two second sub-electrodes. The two second sub-electrodes are proximal to, but separated from, the first sub-electrode. The first sub-electrode and two second sub-electrodes are in a same layer. Optionally, the two second sub-electrodes are spaced apart by a portion of the first sub-electrode.

Optionally, the first electrode includes two or more sub-electrodes. For example, each electrode unit may include a first electrode having two first sub-electrodes and a second electrode having only one second sub-electrode, the second sub-electrode being electrically isolated from the two first sub-electrodes. The two first sub-electrodes are proximal to, but separated from, the second sub-electrode. The second sub-electrode and two first sub-electrodes are in a same layer. Optionally, the two first sub-electrodes are spaced apart by a portion of the second sub-electrode.

The first electrode and the second electrode may be independently controlled. Optionally, the first electrode is electrically connected to a first driving circuit. The second electrode is electrically connected to a second driving circuit different from the first driving circuit. For example, the second driving circuit is a common electrode driving circuit. Optionally, the first electrode and the second electrode are electrically connected to an integrated driving circuit (i.e., the first driving circuit and the second driving circuit may be integrated into the integrated driving circuit).

In some embodiments, the first electrode is operated in a time-division driving mode. For example, the time-division driving mode may include a display mode and a touch control mode. In display mode, the first electrode and the second electrode are common electrodes for applying common voltage signal. In touch control mode, the first electrode is a touch control electrode for conducting touch signals. Accordingly, the first driving circuit acts as a touch electrode driving circuit during touch control mode, and is used as a common electrode driving circuit during display mode. Optionally, a frame period of the display panel having a present display substrate is time-divided into a display period and a touch control period. During the display period, a common voltage signal is applied to the first electrode by driving common voltage signal from the first driving circuit and is applied to the second electrode by driving common voltage signal from the second driving circuit. During the touch control period, the first electrode is driven by the first driving circuit and touch signals are converted into touch data. Optionally, the display period and the touch control period are distinct in time.

In some embodiments, the display substrate further includes an array of pixel electrodes. Optionally, each pixel electrode corresponds to each electrode unit in a one-to-one relationship for image display. Optionally, each electrode unit is at a position corresponding to each pixel electrode in plan view of the display substrate. Optionally, each first electrode is at a position corresponding to each pixel electrode in plan view of the display substrate. Optionally, each second electrode is at a position corresponding to each pixel electrode in plan view of the display substrate.

Optionally, the display substrate is an array substrate. Optionally, the display substrate is a color filter substrate. Optionally, the display substrate is one in a liquid crystal display panel.

In some embodiments, each electrode unit includes a first portion having a first shape and a second portion having a second shape complementary to the first shape, the first portion and the second portion are different electrodes selected from a first electrode and a second electrode. The first shape and the second shape fit together to form a shape of the electrode unit. Optionally, each electrode unit includes a first portion having a first shape and two or more second portions, each second portion having a second shape complementary to the first shape. Optionally, each electrode unit includes a first portion having a first shape and two or more second portions having at least two different second shapes, all of which are complementary to the first shape, Optionally, the first portion is a first electrode and the second portion(s) is a second electrode. Optionally, the first portion is a second electrode and the second portion(s) is a first electrode.

In some embodiments, the first portion has a first complementary region and the second portion has a second complementary region complementary to the first complementary region. The first complementary region and the second complementary region may have any appropriate shapes as long as they are complementary to each other. Optionally, the first portion consists of the first complementary region, the second portion includes the second complementary region and a non-complementary region. Optionally, the second portion consists of the second complementary region, the first portion includes the first complementary region and a non-complementary region. Optionally, the first portion includes the first complementary region and a non-complementary region, the second portion includes the second complementary region and a non-complementary region. Optionally, the first portion consists of the first complementary region, and the second portion consists of the second complementary region.

In some embodiments, the first portion is an inner portion, and the second portion is an outer portion. The inner portion and the outer portion fit together, the inner portion has a shape complementary to the shape of the outer portion. Optionally, the inner portion is the first electrode and the outer portion is the second electrode. Optionally, the inner portion is the second electrode and the outer portion is the first electrode.

In another aspect, the present disclosure provides a method of fabricating a display substrate. In some embodiments, the method includes forming an electrode layer having an array of electrode units on a base substrate; forming a first driving circuit, the first driving circuit is electrically connected to the first electrode; and forming a second driving circuit, the second driving circuit is electrically connected to the second electrode. Each electrode unit includes a first electrode and a second electrode in a one-to-one relationship, the first electrode being electrically isolated from the second electrode. For example, the first electrode may be electrically isolated from the second electrode by a gap. Optionally, to form an electrode layer having this structure, a layer of conductive material may be deposited on a base substrate by sputtering, evaporating, or chemical vapor deposition. The region corresponding to the gap may be removed by etching, e.g., chemical etching, laser etching or mechanical etching. The first electrode is proximal to, but separated from, the second electrode. The first electrode and the second electrode are in a same layer. Optionally, the first electrode and the second electrode are insulated from each other. Optionally, the second electrode is a common electrode for applying common voltage signal for image display.

Optionally, the method includes forming a second electrode having two or more sub-electrodes. For example, each electrode unit may be formed to have a first electrode having only one first sub-electrode and a second electrode having two second sub-electrodes, the first sub-electrode being electrically isolated from the two second sub-electrodes. The two second sub-electrodes are proximal to, but separated from, the first sub-electrode. The first sub-electrode and two second sub-electrodes are formed in a same layer. Optionally, the two second sub-electrodes are formed spaced apart by a portion of the first sub-electrode.

Optionally, the method includes forming a first electrode having two or more sub-electrodes. For example, each electrode unit may be formed to have a first electrode having two first sub-electrodes and a second electrode having only one second sub-electrode, the second sub-electrode being electrically isolated from the two first sub-electrodes. The two first sub-electrodes are proximal to, but separated from, the second sub-electrode. The second sub-electrode and two first sub-electrodes are formed in a same layer. Optionally, the two first sub-electrodes are formed spaced apart by a portion of the second sub-electrode.

In some embodiments, the method further includes forming an array of pixel electrodes. Optionally, each pixel electrode corresponds to each electrode unit in a one-to-one relationship for image display. Optionally, each electrode unit is formed at a position corresponding to each pixel electrode in plan view of the display substrate. Optionally, each first electrode is formed at a position corresponding to each pixel electrode in plan view of the display substrate. Optionally, each second electrode is formed at a position corresponding to each pixel electrode in plan view of the display substrate.

Optionally, the display substrate is an array substrate. Optionally, the display substrate is a color filter substrate. Optionally, the display substrate is one in a liquid crystal display panel.

In some embodiments, each electrode unit is formed to have a first portion having a first shape and a second portion having a second shape complementary to the first shape, the first portion and the second portion are different electrodes selected from a first electrode and a second electrode. The first shape and the second shape fit together to form a shape of the electrode unit. Optionally, each electrode unit is formed to have a first portion having a first shape and two or more second portions, each second portion having a second shape complementary to the first shape. Optionally, each electrode unit is formed to nave a first portion having a first shape and two or more second portions having at least two different second shapes, all of which are complementary to the first shape. Optionally, the first portion is a first electrode and the second portion(s) is a second electrode. Optionally, the first portion is a second electrode and the second portion(s) is a first electrode.

In some embodiments, the first portion has a first complementary region and the second portion has a second complementary region complementary to the first complementary region. The first complementary region and the second complementary region may have any appropriate shapes as long as they are complementary to each other. Optionally, the first complementary region constitutes the entire periphery of the first portion, the second complementary region constitutes a part of the periphery of the second portion. Optionally, the second complementary region constitutes the entire periphery of the second portion, the first complementary region constitutes a part of the periphery of the first portion. Optionally, the first complementary region constitutes a part of the periphery of the first portion, the second complementary region constitutes a part of the periphery of the second portion.

In some embodiments, the first portion is an inner portion, and the second portion is an outer portion. The inner portion and the outer portion fit together, the inner portion has a shape complementary to the shape of the outer portion. Optionally, the inner portion is the first electrode and the outer portion is the second electrode. Optionally, the inner portion is the second electrode and the outer portion is the first electrode.

In another aspect, the present disclosure provides a method of operating a display apparatus. In some embodiments, the method includes driving a common voltage onto a first electrode by a first driving circuit and driving a common voltage onto a second electrode by a second driving circuit, during a display period of a frame period; and generating touch data from signals of the first electrode during a touch control period of the frame period. The display period is distinct in time from the touch control period.

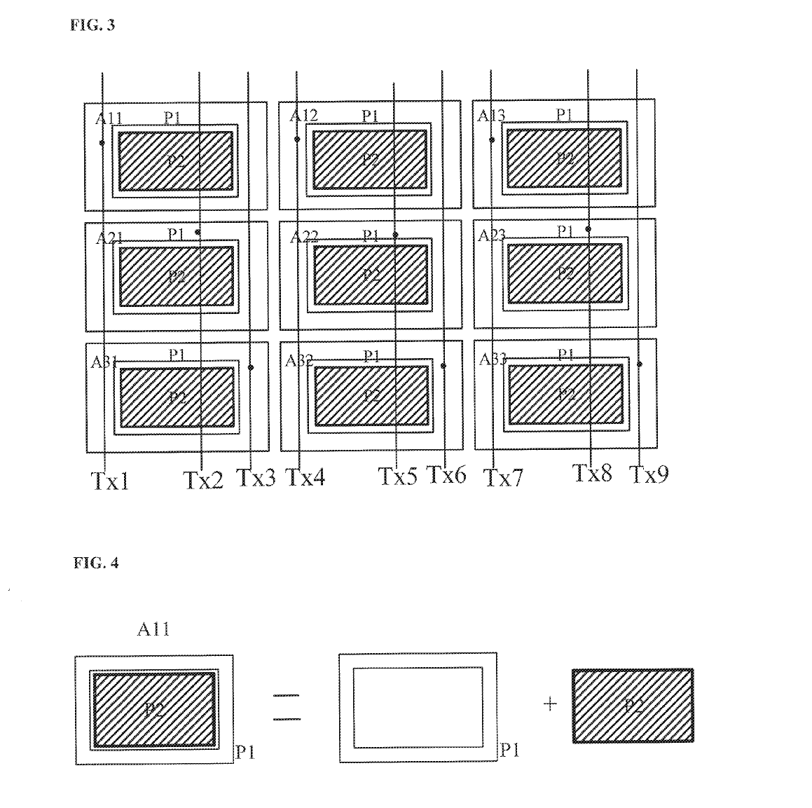

FIG. 3 is a diagram illustrating the structure of a display substrate in some embodiments. Referring to FIG. 3, the display substrate in the embodiment include a plurality of first electrode blocks P1 and second electrode blocks P2. A plurality of electrically connected first electrode blocks P1 constitute a touch electrode of the display substrate. The first electrode blocks P1 are used for conducting touch signals in touch con mode, and for applying common voltage in display mode. In display mode, both the first electrode blocks P1 and the second electrode blocks P2 are used for applying common voltage.

Each first electrode block P1 is arranged in a one-to-one relationship with each second electrode block P2, together forming a combined electrode block. For example, the display substrate in FIG. 3 includes a plurality of combined electrode blocks A11, A12, A13, A21, A22, A23, A31, A32, A33, each of which includes a first electrode block P1 and a second electrode block P2. The first electrode block P1 and the second electrode block P2 in each combined electrode block are spaced apart and may be independently controlled.

The combined electrode block, the first electrode block P1, and the second electrode block P2 may have any appropriate shape and/or spatial arrangement. For example, any of the combined electrode block, the first electrode block P1, and the second electrode block P2 may be a circle, a rectangle, a triangle, or a rhomboid. In some embodiments, the electrode block P1 and the second electrode block P2 have a similar shape. In some embodiments, the electrode block P1 and the second electrode block P2 have different shapes. Optionally, each first electrode block P1 is an inner electrode block surrounded by a corresponding second electrode block P2. Optionally, each second electrode block P2 is an inner electrode block surrounded by a corresponding first electrode block P1. Optionally, the inner electrode has a shape complementary to the outer electrode.

FIG. 4 is a diagram illustrating the structure of a combined electrode A11 having a first electrode block (P1) and a second electrode block (P2) in some embodiments, Referring to FIG. 4, a combined electrode A11 has an inner electrode block P2 and an outer electrode block P1 (shadowed area) surrounding the inner electrode block P2. In FIG. 4, the combined electrode block A11 and the second electrode block P2 are of rectangular shape, the first electrode block P1 is a hollow rectangle. The hollow portion of P1 has an area substantially the same as that of P2.

Optionally, all first electrode blocks P1 in the display substrate have a uniform shape and dimension to ensure touch control uniformity. Optionally, all second electrode blocks P2 in the display substrate have a uniform shape and dimension. Optionally, all combined electrode blocks in the display substrate have a. uniform shape and dimension.

Numerous alternative embodiments may be practiced to make a combined electrode block. For example, the first electrode block P1 and the corresponding second electrode block P2 may be combined in a side-by-side relationship. In some instances, the combined. electrode block includes an upper portion P1 and a lower portion P2. In some instances, the combined electrode block includes a left portion P1 and a right portion P2.

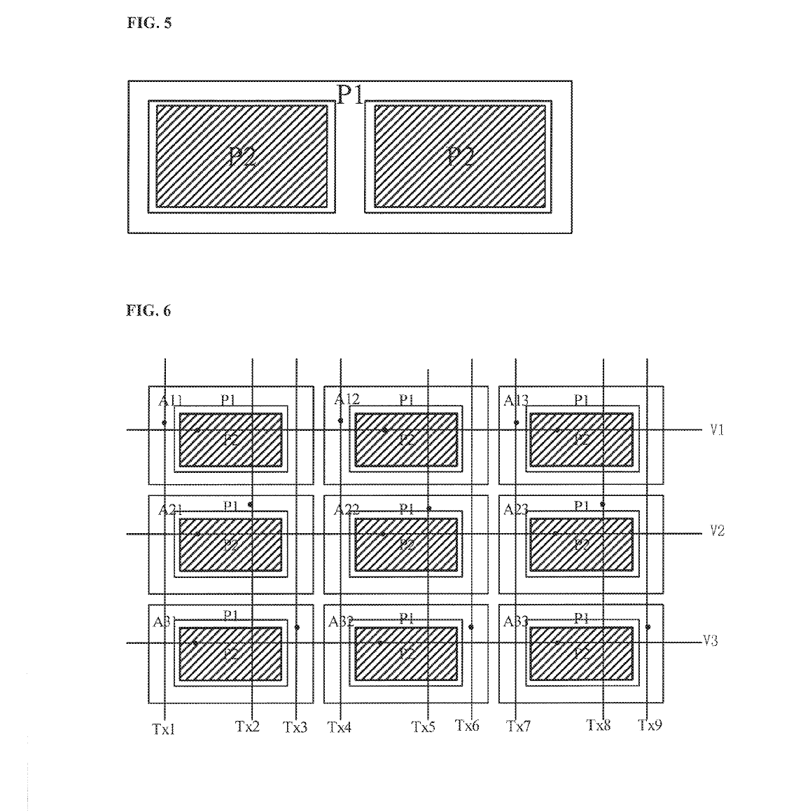

FIG, 5 is a diagram illustrating the structure of a combined electrode block having a first electrode block (P1) and two second electrode blocks (P2) in some embodiments. Referring to FIG. 5, each combined electrode block in the embodiment includes a first electrode block P1 and two second electrode blocks P2. The two second electrode blocks P2 are spaced apart. Two second electrode blocks P2 may have a same shape and dimension. Optionally, two second electrode blocks P2 have different shapes and dimensions. The second electrode blocks P2 may have any appropriate shape. In FIG. 5, two second electrode blocks P2 are rectangles.

In some embodiments, all first electrode blocks have a uniform shape and dimension, all second electrode blocks have a uniform shape and dimension (see, e.g., FIG. 3). Optionally, all first electrode blocks are rectangles, all second electrode blocks are rectangles, and all combined electrode blocks are rectangles. A display substrate having this design has a regular shape and structure.

The combined electrode block may have any appropriate shape, e.g., a rectangle or a square. Optionally, the combined electrode block is a rectangle (see, e.g., FIG. 3, FIG. 5). The display substrate includes an array of rectangular combined electrodes.

In some embodiments, the display substrate is a touch control substrate capable of multi-point, simultaneous touch control. Optionally, each touch electrode in the multi-point touch control substrate includes a plurality of electrically connected first electrodes P1. Optionally, the plurality of electrically connected first electrodes P1 are arranged in a same row. Optionally, the plurality of electrically connected first electrodes P1 are arranged in a same column. The plurality of electrically connected first electrodes P1 are connected by a wire. Optionally, the connecting wire is a straight line extending through each first electrode block P1. Optionally, the wire is a transparent wire.

In some embodiments, the electrodes are operated in time-division driving mode. The first electrode blocks P1 are electrically connected to a driving circuit located in a peripheral region of the display panel, and the second electrode blocks P2 arc electrically connected to a different driving circuit in the peripheral region. In touch control mode, the driving circuit provides touch signals to the first electrode blocks P1. In display mode, the driving circuit provides common voltage signals to the first electrode blocks P1 and the second electrode blocks P2.

In some embodiments, each first electrode block P1 is independently connected to the driving circuit though an individual wire. As shown in FIG. 3, the first electrode blocks in the embodiment are independently connected to the driving circuit through the wires Tx1-Tx9. Optionally, each second electrode block P2 is independently connected to a different driving circuit. Optionally, each first electrode block P1 and each second electrode block P2 are independently connected to the driving circuits.

By having each first electrode block P1 and each second electrode block P2 independently connected to the driving circuits, each electrode can be individually scanned by the driving circuits, resulting in an improved scanning accuracy.

Optionally, each first electrode block P1 is independently connected to the driving circuit, a plurality of electrically connected second electrode blocks P2 (e.g., in a same row or in a same column) are connected with each other and to a driving circuit through a wire. As shown in FIG. 3 and FIG. 6, the first electrode blocks P1 are independently connected to the driving circuit through Tx1-Tx9, respectively. As shown in FIG. 6, a plurality of second electrode blocks P2 in a same row are connected with each other and a driving circuit through a wire (e.g., V1-V3 in FIG. 6). Optionally, a plurality of second electrode blocks P2 in a same column may be connected with each other and to a driving circuit through a wire.

By having each first electrode block P1 independently connected to the driving circuit, and the plurality of electrically connected second electrode blocks P2 connected with each other and to a driving circuit through a wire, the second electrode blocks may be scanned by the driving circuit row by row (or column by column), resulting in a higher scanning speed.

The connecting wire can be formed in a separate layer or in a same layer as other components of the display substrate. Optionally, the connecting wire is fabricated by forming a metal layer on the substrate followed up patterning the metal layer to obtain the connecting wire. Optionally, the connecting wire is formed in a same process as other components of the display substrate. For example, the connecting wire may be formed in a same process as a gate electrode or a source drain electrode. Having the connecting wire fabricated in a separate layer simplifies the connecting wire forming process, and avoids any potential intermingling with other wires and metal layers. Having the connecting wire formed in a same layer as other components simplifies the manufacturing process, and results in a more streamlined structure.

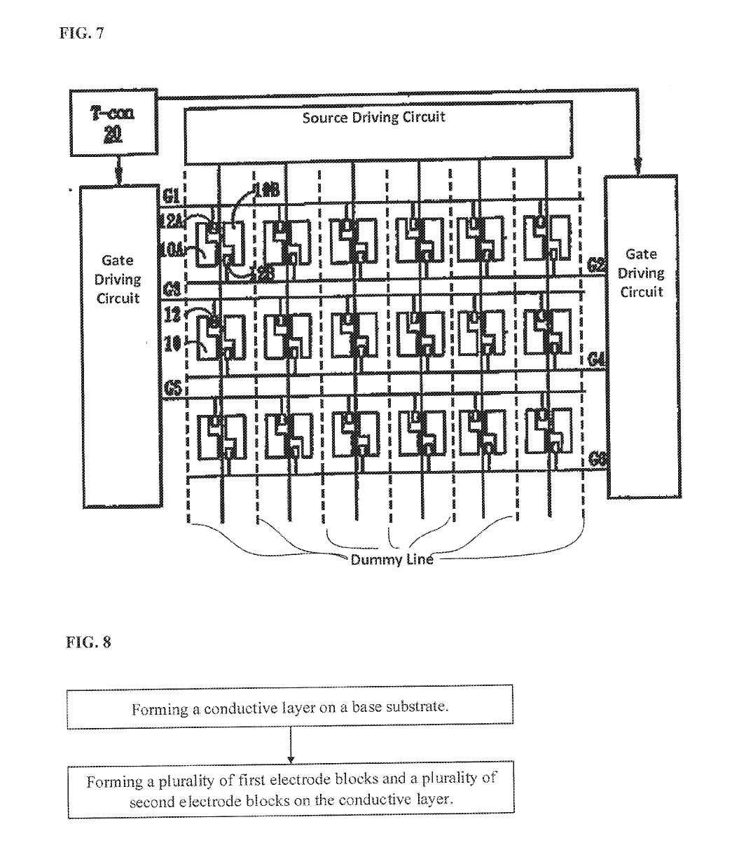

In some embodiments, the display substrate is a dual gate-type display substrate. FIG. 7 is a diagram illustrating the structure of a dual gate-type display substrate in some embodiments. Referring to FIG. 7, a dual gate-type display substrate includes a plurality of dummy lines for eliminating the effect of imbalanced impacts of data lines on the pixels. Optionally, the dummy lines in the dual gate-type display substrate may be used as the connecting wire.

In some embodiments, the display substrate further includes an array of pixel electrodes. Optionally, the first electrode blocks are arranged in areas corresponding to the pixel electrodes. For example, the first electrode blocks may be disposed on top of the pixel electrodes.

In a conventional display substrate, an entire electrode block is used as the touch electrode in touch control mode (see, e.g., A11 in FIG. 1). In contrast, only a portion of the combined electrode block, i.e., the first electrode block P1, is used as the touch electrode during touch control mode in the present display substrate (see, e.g., P1 of A11 in FIG. 3). Provided that the surface areas of A11 in FIG. 1 and FIG. 3 are the same, the touch electrode in the present display substrate has a much smaller surface area as compared to that of the convention display substrate. A smaller surface area of the touch electrode results in a smaller touch electrode capacitance. A decreased touch electrode capacitance in turn decreases the charging time duration T required for achieving the voltage required for the touch electrode to be operable (V₁). Accordingly, touch sensitivity of the present display substrate ran be significantly enhanced.

In another aspect, the present disclosure provides a method of fabricating a display substrate. FIG. 8 is a flow chart illustrating a method of fabricating a display substrate in some embodiments. Referring to FIG. 8, the method in the embodiment includes forming a conductive layer on a base substrate; and forming a plurality of first electrode blocks and a plurality of second electrode blocks on the conductive layer. In touch control mode, the first electrode blocks are used for conducting touch signals. In display mode, both the first electrode blocks and the second electrode blocks are used for applying common voltage signals. Optionally, each first electrode block is a touch electrode of the display substrate. Optionally, a plurality of electrically connected first electrode blocks constitute a touch electrode of the display substrate (e.g., in a multi-point touch control display substrate). Optionally, the conductive layer is a common electrode layer.

In some embodiments, the step of forming a plurality of first electrode blocks and a plurality of second electrode blocks includes partitioning the conductive layer into a plurality of electrode blocks (e.g., by a patterning process); and partitioning each electrode block into a first electrode block and a second electrode block (e.g., by a patterning process). Optionally, the step of partitioning the conductive layer may be performed using a cell process. The number of electrode blocks to be partitioned on the conductive layer can be determined based on the design and application of the display substrate.

The first electrode block and the second electrode block may have any appropriate shape, dimension, and/or spatial arrangement as discussed above. The working principle of the first electrode block and the second electrode block is also discussed above.

In the present method, the conducive layer (e.g., a common electrode layer) is patterned to form a plurality of first electrode blocks and a plurality of second electrode blocks. In touch control mode, each first electrode block, or each group of a plurality of electrically connected first electrode blocks, can be used as a touch electrode. In display mode, both the first electrode blocks and the second electrode blocks are used as common electrodes. As compared to a conventional display substrate, a display substrate fabricated by the present method uses only the first electrode block as the touch electrode. Thus, the touch electrode in the display substrate fabricated by the present method has a much smaller surface area as compared to that of the convention display substrate. A smaller surface area of the touch electrode results in a smaller touch electrode capacitance. A decreased touch electrode capacitance in turn decreases the charging time duration T required for achieving the voltage required for the touch electrode to be operable (V₁). Accordingly, touch sensitivity of the display substrate fabricated by the present method can be significantly enhanced.

In some embodiments, the method further includes forming a wire connecting a plurality of first electrode blocks which constitute a touch electrode (e.g., for multi-point touch sensing). In some embodiments, the method further includes forming a plurality of wires, each of which connecting a plurality of second electrode blocks (e.g., in a row, or in a column). Optionally, the method includes forming a wire connecting a plurality of first electrode blocks which constitute a touch electrode (e.g., for multi-point touch sensing); and forming a plurality of wires, each of which connecting a plurality of second electrode blocks (e.g., in a row, or in a column).

In some embodiments, the method further includes forming a plurality of wires, each of which independently connecting each first electrode block to a driving circuit. In some embodiments, the method further includes forming a plurality of wires, each of which independently connecting each second electrode block to a driving circuit. Optionally, the method includes forming a plurality of wires, each of which independently connecting each first electrode block to a driving circuit; and forming a plurality of wires, each of which independently connecting each second electrode block to a driving circuit. By having each first electrode block and/or each second electrode block independently connected to the driving circuits, each electrode can be individually scanned by the driving circuits, resulting in an improved scanning accuracy.

In some embodiments, the method further includes forming a plurality of wires, each of which independently connecting each first electrode block to a driving circuit. In some embodiments, the method further includes forming a plurality of wires, each of which connecting a plurality of second electrode blocks (e.g., in a row, or in a colunm) to a driving circuit. Optionally, the method includes forming a plurality of wires, each of which independently connecting each first electrode block to a driving circuit; and forming a plurality of wires, each of which connecting a plurality of second electrode blocks (e.g., in a row, or in a column) to a driving circuit. By having each first electrode block P1 independently connected to the driving circuit, and the plurality of electrically connected second electrode blocks P2 connected with each other and to a driving circuit through a wire, the second electrode blocks may be scanned by the driving circuit row by row column by column), resulting in a higher scanning speed.

In another aspect, the present disclosure provides a display device having a display substrate described herein or manufactured by a method described herein. Examples of apparatuses include, but are not limited to, an electronic paper, a mobile phone, a tablet computer, a television, a notebook computer, a monitor, a digital album, a GPS, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A display substrate, comprising:
an electrode layer comprising an array of electrode units; each electrode unit comprises a first electrode and a second electrode in a one-to-one relationship; the first electrode is electrically isolated from the second electrode;
wherein the second electrode is a common electrode being controlled independently from the first electrode.

2. (canceled)

3. (canceled)

4. The display substrate of claim 1, wherein each electrode unit comprises a first portion having a first shape and a second portion having a second shape complementary to the first shape, the first portion and the second portion are different electrodes selected from the first electrode and the second electrode.

5. The display substrate of claim 4, wherein the second portion is an inner portion and the first portion is an outer portion surrounding the inner portion;
the inner portion is the first electrode and the outer portion is the second electrode.

6. The display substrate of claim 4, wherein the second portion is an inner portion and the first portion is an outer portion surrounding the inner portion;
the inner portion is the second electrode and the outer portion is the first electrode.

7. The display substrate of claim 4, wherein the first shape is a rectangle, a triangle, or a rhomboid.

8. The display substrate of claim 1, wherein all first electrodes have a substantially uniform shape and dimension, and all second electrodes have a substantially uniform shape and dimension.

9. The display substrate of claim 1, wherein a plurality of first electrodes along a same array direction are electrically connected.

10. The display substrate of claim 9, wherein the plurality of first electrodes are electrically connected by a first wire, the first wire being a transparent wire extending through each of the plurality of first electrodes.

11. The display substrate of claim 9, wherein a plurality of second electrodes along a same array direction are electrically connected by a second wire.

12. The display substrate of claim 10, wherein the display substrate is a dual gate-type display substrate, the first wire and/or the second wire are dummy lines in the dual gate-type display substrate.

13. The display substrate of claim 1, further comprising an array of pixel electrodes; each pixel electrode corresponding to each electrode unit in a one-to-one relationship.

14. The display substrate of claim 13, wherein each first electrode is at a position corresponding to each pixel electrode in plan view of the display substrate.

15. A method of fabricating a display substrate, comprising:
forming an electrode layer comprising an array of electrode units on a base substrate; each electrode unit comprises a first electrode and a second electrode in a one-to-one relationship; the first electrode is electrically isolated from the second electrode; the second electrode is a common electrode; and
forming at least one driving circuit for controlling the first electrode and the second electrode independently.

16. The method of claim 15, further comprising forming an array of pixel electrodes; each pixel electrode corresponding to each electrode unit in a one-to-one relationship.

17. (canceled)

18. (canceled)

19. (canceled)

20. (canceled)

21. The method of claim 15, wherein the step of forming an electrode layer comprises:
forming a conductive layer on the base substrate; and
partitioning the conductive layer into a plurality of electrode blocks, each electrode block comprising a first electrode and a second electrode.

22. The method of claim 15, further comprising forming a first wire connecting a plurality of first electrodes along a same array direction.

23. The method of claim 15, further comprising forming a second wire connecting a plurality of second electrodes along a same array direction.

24. The method of claim 22, wherein the display substrate is a dual gate-type display substrate, the method further comprising:
forming a plurality of dummy lines in the dual gate-type display substrate;
wherein the first wire and/or the second wire are dummy lines in the dual gate-type display substrate.

25. A display apparatus, comprising the display substrate of claim 1.

26. A method of driving a display apparatus of claim 25, wherein one frame period is temporally divided into a display mode for displaying an image in a display panel and a touch control mode for sensing a user touch, the display panel is alternately driven in the display mode and in the touch control mode, the method comprising:
applying a common voltage to the first electrode and the second electrode during the display mode; and
applying a touch scan signal to the first electrode during the touch control mode.
